(19) United States
(12) Patent Application Publication
(10) Pub. No.: US 2009/0157467 A1
(43) Pub. Date: Jun. 18, 2009

(54) Method and apparatus for controlling access to and generating revenue from a portable lavatory

(76) Inventor: Earl J. Braxton, Shelby Township, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 12/002,035

(22) Filed: Dec. 14, 2007

(51) Int. Cl. G06Q 10/00

(52) U.S. Cl. 705/9; 705/1

(57) ABSTRACT

A method and apparatus for controlling access to and generating revenue from a portable lavatory. The portable lavatory is placed at a predetermined location and a barrier is established around the portable lavatory to block unauthorized access to the portable lavatory. An entrance or passageway is provided through the barrier enabling access to the portable lavatory. Passes are distributed to those individuals desiring to utilize the portable lavatory and upon presentation of the passes to an attendant stationed at the entrance or passageway, the individuals are granted access to the portable lavatory. By charging individuals to obtain a pass the portable lavatory generates revenue.

### CROSS-REFERENCE TO RELATED APPLICATIONS

Not Applicable

### FEDERALLY SPONSORED RESEARCH OR DEVELOPMENT

Not Applicable

### REFERENCE TO SEQUENCE LISTING

Not Applicable

### BACKGROUND OF THE INVENTION

1. Field of the Invention

The present invention relates to portable lavatories. More specifically, this invention is directed to a method and apparatus for controlling access to and generating revenue from custodian administered, flushable, portable lavatories, including comfort stations.

2. Description of Related Art

Portable lavatories are widely used throughout the world at construction sites, outdoor public events, and other points-of-use having large gatherings of people. A portable lavatory generally includes a base, four walls including a door, and a roof. Mounted within is a waste tank positioned on the base, the waste tank having a top surface with an opening therethrough and a toilet seat hingeably mounted over the opening. The waste material drops, under the influence of gravity, into the tank where it accumulates until collected. The waste tank is pumped out through the toilet opening as needed.

With a conventional portable lavatory the waste tank and the waste therein, is open to the inside of the enclosure. This open condition subjects each user of the portable toilet to the unsightly waste in the waste tank and to the unpleasant odors emanating therefrom. A related problem is that chemicals must be added to the waste tank to reduce the odor and bacteria levels. Another disadvantage is that the typical portable lavatory has a limited waste capacity and requires interruption of use to pump out the waste. This is accomplished by entering the portable toilet as any user would, with a vacuum suction hose and sucking out the waste through the opening in the top surface. This is extremely unsanitary. Finally, since conventional portable lavatories rely on gravity to flow waste to the storage tank, conventional portable lavatories must be elevated to accommodate a larger waste material storage tank that is positioned under the toilet, whereby such lavatories require steps making such lavatories non-compliant with the Americans with Disabilities Act (ADA).

U.S. Pat. No. 6,615,414 to Miller, discloses another type of portable lavatory, that typically includes a flush toilet having a toilet bowl, a toilet tank, a waste line and a waste tank. The toilet bowl is mounted to the base within the enclosure. The waste tank is positioned outside and behind the enclosure. The toilet bowl is connected to a waste line that extends outside the enclosure such that the odor from any waste disposal will not contaminate the area within the enclosure. The waste line is connected to the holding tank. The waste line may terminate over a sewage drain or septic field in alternate embodiments. A toilet tank is mounted above the toilet bowl to one of the wall panels. The toilet tank is fluidly connected, such that fluid flows therethrough, to the toilet bowl and provides fresh water for flushing the toilet bowl.

As further illustrated in the '414 patent, the portable lavatory may optionally include a wash basin mounted within the enclosure to a wall panel and includes a drain line extending therefrom that connects to the waste line. A fresh water supply line extends through one of the wall panels of the enclosure and is fluidly connected to the toilet tank and to the wash basin for supplying fresh water thereto. Alternately, an on-demand tankless gas heater can be used to heat the fresh water to provide hot tap water to the wash basin.

While Miller discloses the toilet disclosed as a portable toilet there is no disclosure or teaching whatsoever regarding the disassembly of the portable toilet for transporting or moving the toilet from one site to another site. Further, Miller discloses that in order for this portable toilet to be in compliance with the Americans with Disabilities Act, it is necessary to include a ramp with a ledge to prevent wheelchairs from accidentally falling from the ramp. Further for such use, the toilet, sink, and urinal are of a different size and the floor must be non-grated while the stall itself must be of sufficient size to accommodate a wheelchair. It is clear that major changes must be made to the toilet facility in order to comply with the ADA.

Further, Miller is completely silent with respect to maintenance requirements and how these portable toilets are expected to remain in a clean usable condition due to user created rubbish and contaminants associated with the public use of toilets.

U.S. Pat. No. 5,647,074 to White discloses a self-cleaning, automatic public toilet facility permanently mounted on a concrete slab suited for sidewalk use. White discloses that public, sidewalk pay toilets are common in Europe and have been used in major cities in New York and San Francisco. Such public toilets are typically permanently mounted, unattended and do not include a wash basin or sink or any type of cleanup facility for the user. With such sidewalk pay toilets the user pays cash, typically in the form of coins to use the toilet. Accordingly, the costs associated with collecting and safeguarding the money and associated mechanisms to secure and operate the facility can be extensive. Because of the closed-in nature of the structures, there is a tendency for rubbish to accumulate in the user compartments. Further, the hygienic and sanitary condition of the lavatory is a large factor in an individual's decision to use the lavatory and thus greatly affects any revenue generated by the lavatory. Although mounted on a concrete slab, these lavatory units are not easily moveable to other sites if the need arises. Also like most other prior art toilets, special accommodations are necessary to comply with the ADA. While disclosure as to how the portable toilets are to maintain their sanitary conditions after public use generated trash and rubbish is completely lacking.

Portable lavatories, as set forth above, are generally used at events such as fairs, carnivals, festivals, parades, sporting events, concerts, national disasters, or other temporary gatherings of individuals. For example, in order to put on an event, such as a festival or fair, the promoter or organizer thereof is typically required to provide sanitation facilities at the event suitable to meet the needs of the individuals attending the event including individuals with disabilities. Normally, depending upon the size of the event, the event organizer provides a predetermined number of drop tank portable lavatories. Supplying the predetermined number of drop tank portable lavatories results in an expense to the provider or organizer of the event. Further, many individuals attending these events understand that such sanitation facilities, typically a portable lavatory utilizing a waste tank located within the enclosure, are usually in less than a hygienic and sanitary condition and completely fail to recognize the need of disabled individuals. Further, such units often do not include a wash basin for hand washing. Since providing sanitation facilities is typically viewed as an expense, many organizers provide only minimum sanitation facilities that often detract from the overall impression of the event as individuals typically remember or often associate the event with the condition of the sanitation facilities. Accordingly, generating revenue from such minimum sanitation facilities, such as those having a waste tank in the enclosure, is typically not possible whereby they result in an expense to the event promoter or organizer.

From the above, it can be appreciated that there is a need to optimize or generate revenue from the use of portable lavatories. Therefore, what is needed is a method and apparatus for controlling and limiting access to individuals who have previously paid to obtain access to a portable lavatory. Controlling access to the portable lavatory is one way in which the event promoter or organizer may provide a more sanitary and hygienic portable lavatory and thereby enhance the overall impression of the event while at the same time enabling the event organizer to offset the cost of and generate revenue from the use of the portable lavatory. Further, it should be appreciated that enhancing the portable lavatory facilities may be a selling point of the event and provide a value added service to the event.

### SUMMARY OF THE INVENTION

According to the preferred embodiment of the present invention, there is provided a method for controlling access to a portable lavatory. The method includes the step of placing one or more portable lavatories compliant with the Americans with Disabilities Act at a predetermined location. After the lavatory is suitably located, a barrier is established around the portable lavatory to block unauthorized access to the portable lavatory. A passageway through the barrier provides access to the portable lavatory. The method includes making available a means for purchasing at least one pass granting access to use the portable lavatory, as well as providing a means for maintaining sanitary and hygienic conditions after each use. Accordingly, a custodian stationed within the barrier upon being presented with the pass grants access to the use of the portable lavatory after the portable lavatory is inspected by the custodian and any unsanitary condition is removed therefrom by timely cleaning by the custodian.

According to an additional embodiment of the invention, there is provided a sanitation concession including a portable lavatory, a barrier surrounding the portable lavatory, a pass dispensing scheme, and a custodian.

The barrier surrounding the portable lavatory limits unauthorized access to the portable lavatory and has a passage allowing an individual with a previously purchased pass to gain access through the barrier by showing the pass to the custodian and use the lavatory. The pass dispensing scheme may be spaced separate from the passage and is operative to dispense a pass. Alternatively, the custodian stationed proximate the barrier may dispense a pass for a set fee, as well as reviews previously purchased passes and allows access to use the portable lavatory upon presentation of a valid pass.

It is an object of the present invention to provide as part of the method a pass distribution scheme preferably separate and spaced from the custodian, wherein a pass distribution scheme dispenses the pass granting access to the lavatory.

It is another object to provide a pass having indicia thereon, indicating the number of times the pass can be used whereby the method further includes the step of the custodian examining each pass and making a determination that the pass is valid and has not exceeded its maximum use.

It is still another object of the present invention that the portable lavatory is a comfort station in complete compliance with the Americans with Disabilities Act.

It is yet a further object of the present invention that the custodian inspects the portable toilet before each use and removes therefrom any debris or clean up any unsanitary condition that may occur from a prior user.

It is yet a further object of the present invention that the custodian's primary duties are to inspect and maintain cleanliness of each portable toilet while administering access to the portable toilets for users with a valid pass. Under special conditions, it is also expected that valid passes for the use of the portable toilets may directly be purchased for cash from the custodian.

It is yet a further object of the present invention to generate revenue from a portable lavatory by charging for access to use the portable lavatory.

These objects and other features, aspects and advantages of this invention will be more apparent after a reading of the following detailed description, appended claims and accompanying drawings.

### BRIEF DESCRIPTION OF THE DRAWINGS

FIG. 1 is a schematic representation of a sanitation concession according to the present invention; and

FIG. 2 is a perspective view of a portable lavatory of a type suitable for use with the sanitation concession illustrated in FIG. 1.

### DETAILED DESCRIPTION OF THE PREFERRED EMBODIMENT

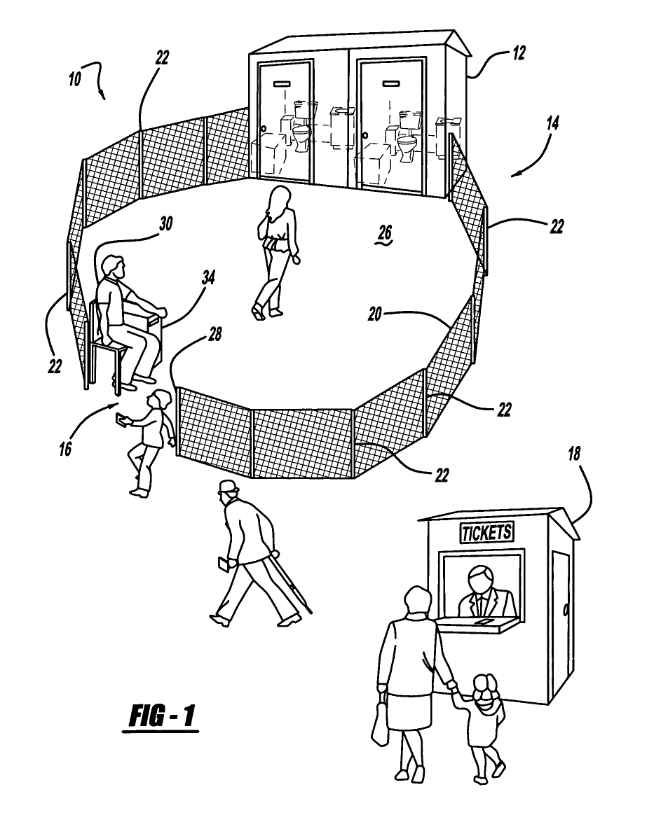

With reference to FIG. 1, there is shown a sanitation concession, seen generally at 10. The sanitation concession 10 includes a portable lavatory 12, a barrier 14 surrounding and limiting unauthorized access to the portable lavatory 12. As illustrated in FIG. 1, one example of such a barrier 14 is a fence 20 erected such that it surrounds the portable lavatory 12. The fence 20 can be formed of an expandable diamond mesh plastic material that typically comes in a roll. The fence 20 is typically reusable and is rerolled for subsequent use. A plurality of fence posts 22 support the fence 20. Depending upon the ground surface at the particular location of the sanitation concession 10, the fence posts 22 are driven into the ground surface or secured to a base or support (not shown) when the fence 20 is located over a hard surface such as pavement. The fence 20 limits access to the portable lavatory 12 and establishes a curtilage or area 26 inside the fence 20 wherein an individual may wait to enter the portable lavatory 12. The barrier 14 includes a passage 16 through which an individual gains access to the portable lavatory 12. One example of a passage 16 is to form an opening 28 in the fence 20 through which an individual may pass. While in the disclosed embodiment, the passage 16 is an opening 28 in the fence 20 with a custodian 30, stationed adjacent the passage 16, the passage 16 may also utilize some type of limiting mechanism such as a gate, turnstile, swinging door or revolving door. The sanitation concession 10 further includes a pass dispensing scheme utilizing any one of several methods of purchasing a valid pass to gain authorized access to the portable lavatory 12. For example, it is the preferred embodiment to obtain passes from a pass dispensing mechanism or ticket booth 18 located on the same grounds as the event, fair, carnival, festival, parade, sporting event or concert and the like. The passes may also be obtained as part of the cost to attend the event. A pass allowing any number of uses of the portable toilet facility may be purchased at the time of purchasing the initial admission ticket. Further it is contemplated that a pass may be purchased from a portable toilet pass vending machine located near the site of the toilet. As a last resort, passes may also be purchased from the custodian 30 for cash. However, such is only for emergency situations and is to be avoided for the obvious reasons, including to avoid risk of the custodian 30 of robberies and thefts of the cash collected. Other pass dispensing schemes are also contemplated.

Further, the custodian 30 is located at a custodian station 34 positioned near or proximate the passage 16. As used herein, the term portable lavatory means at least an enclosure with one or more flushable, porcelain toilets and includes a facility for washing of a user's hands after use of the portable lavatory 12.

As illustrated in FIG. 1 the pass dispensing mechanism 18, shown as a booth staffed by an individual, is located at a position spaced from the portable lavatory 12 and may be located any where on the grounds of where the event occurs. Accordingly, an individual desiring to use the portable lavatory 12 must first obtain a pass from a pass dispensing mechanism 18. Typically, a pass is obtained by tendering a sum certain or predetermined amount of money to the individual located in the ticket booth 18 who then issues the pass. It should be understood that the pass dispensing mechanism 18 may be an apparatus or machine that accepts payment and dispenses passes or, as set forth above, can be purchased with the reserved ticket to attend the event. For example, the apparatus can be a machine having a controller, processor with associated memory, payment acceptor module, pass dispensing module, which may include a printer, and an input module accepting input from a user desiring to obtain a pass. Thus, the machine is capable of accepting user input and payment and dispensing a pass. Many such systems are known for use with accepting payment and dispensing an item. Further, such systems rather than accepting a cash payment, can be used with credit and debit cards having a magnetic stripe or smart card reader/writer or may utilize a barcode scanner.

The invention further contemplates that if the portable lavatory 12 is used at a temporary event such as a fair, carnival, festival, parade, sporting event, or concert that the ticket purchased to attend the event includes certain limited access to use the portable lavatory 12 or alternatively, passes for use of the portable lavatory 12 may be purchased from the same service that sells the tickets to gain access to the event itself. Appropriate security considerations must also be considered when selecting a scheme to sell passes for access to the portable lavatory 12.

Accordingly, it should be understood that the pass is preferably not obtained from the custodian 30 to use the portable lavatory 12, but the custodian's 30 primary responsibility is to keep the lavatory facilities clean and in an emergency the custodian 30 can accept payment upon being presented with a valid pass allowing the holder thereof access to the portable lavatories 12.

Further, it should be understood that in some instances, the custodian 30 may be replaced with a pass identification and passage control mechanism that upon receiving a valid pass allows passage through the barrier 14 to provide access to the portable lavatory 12. For example, the pass identification mechanism may be a magnetic stripe reader that accepts a card or pass having usage information coded thereon, wherein inserting or swiping the card or pass correspondingly sends a usage signal to a controller or control unit. The controller upon confirming that the pass is valid for use sends a corresponding signal to the passage control mechanism, for example a turnstile or gate, to allow the user access to the portable lavatory 12. As used herein access to the portable lavatory 12 means access to the curtilage or area 26 within the barrier 14 adjacent the portable lavatory 12 as the present invention contemplates a plurality of individual lavatories located within the area 26 enclosed by the barrier 14. Therefore, upon passing through the barrier 14 an individual may access any of the portable lavatories 12 enclosed within the barrier 14. However, the custodian 30 will still be present to control the orderly access to the portable lavatories 12 as well as to tend to the cleaning duties between uses.

As disclosed herein the term portable lavatory may also include a portable and modular comfort station having an enclosure, a porcelain wash basin and a porcelain flush toilet. The comfort station further has a waste tank positioned outside and behind the enclosure, wherein a porcelain toilet bowl located within the enclosure is connected through a P-trap to the waste tank by a waste line such that the waste is flushed outside the enclosure. One example of a comfort station suitable for use with the present invention is disclosed in U.S. Pat. No. 6,721,967, owned by the inventor hereof, the entire disclosure and contents of which are herein incorporated by reference.

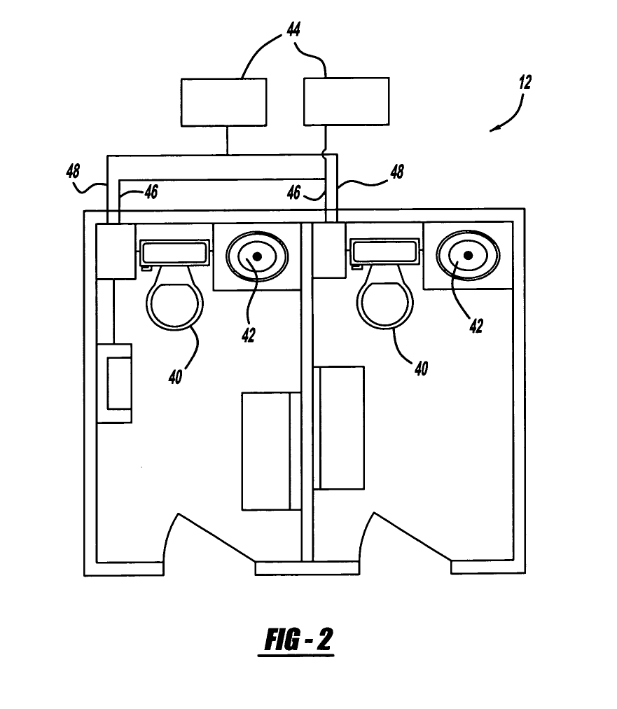

In one embodiment, a portable lavatory 12 or as referred to above a comfort station for use with the present invention is disclosed in FIG. 2. The portable lavatory 12 includes an enclosure having a porcelain toilet 40 and a porcelain wash basin 42. A waste tank 44 is located outside of the enclosure. The porcelain toilet 40 is connected to the waste tank 44 by a waste line 46. The porcelain wash basin 42 also has a waste line 48 connecting the porcelain wash basin 42 to the waste tank 44. In addition, fresh water lines (not shown) are connected to both the porcelain toilet 40 and the porcelain wash basin 42. Such a portable lavatory 12 provides a more comfortable, sanitary and hygienic lavatory that reduces undesirable odor.

The portable lavatory 12 is delivered to a point-of-use either fully assembled with the waste tank 44 and waste line 46, 48 stored inside the enclosure or is delivered in a disassembled state for on-site assembly. In either case, on-site preparation is minimal compared to the prior art. First, the waste tanks 44 are placed outside the enclosure and the waste lines 46, 48 connected between the waste tank 44 and the porcelain toilet 40. Then a length of water supply hose (not shown) is externally connected to the bulkhead fitting and the portable lavatory 12 is operational. The length of water supply hose is easily connected to a water supply truck, a water tank, a well source, or a building with running water if conveniently available.

Accordingly, the comfort station is superior to the prior art for several reasons. Primarily, the portable lavatory 12 does not recycle any fluids through the toilet fixtures and thus eliminates any related odor and the need for chemical treatment. Additionally, the portable lavatory 12 includes not only a porcelain toilet 40 but also includes a porcelain wash basin 42 with fresh, hot and cold running water. A user can wash up after using the porcelain toilet 40, thus rendering the comfort station more versatile and desirable to a wider base of clientele. Further, the portable lavatory 12 does not require electrical hook ups to operate. Finally, the portable lavatory 12 is modular and therefore easily-expandable to more efficiently service greater numbers of people. It can be seen that such a portable lavatory 12 has value, whereby such a portable lavatory 12 can be used at an event to generate revenue. Revenue being generated by charging for access to the portable lavatory 12 whereby those individuals who have previously paid may use the portable lavatory 12. The portable lavatory 12 is also provided with a paper towel dispenser, waste basket, and diaper changing station.

The present invention further includes a method for controlling access to a portable lavatory 12. The portable lavatory 12 is of modular construction and can be transported to an event site and assembled at the event location for use during the event. The portable lavatory 12 is such that it can be utilized outside or in a covered area, including a temporary or permanent shelter for example a pavilion, cover, awning or canopy. Further, the portable lavatory 12 is suitable for use within the confines of a building.

Initially, the portable lavatory 12 is delivered, or assembled and placed at a predetermined location. Consequently, when the portable lavatory 12 is no longer needed, the portable lavatory 12 can be removed by disassembling it or using material handling equipment, such as a forklift, to place it fully assembled on a vehicle for transportation. In addition, it is contemplated that in some instances the portable lavatory 12 may have its own power source, for example, the portable lavatory 12 can be placed on a movable platform whereby the platform has its own drive system.

While typically placing the portable lavatory 12 at the predetermined location is the first step, after which the barrier 14 is established around the portable lavatory 12, there is no requirement that the sanitation concession 10 be set up in such a manner. Applicant contemplates that the barrier 14 can be set up first thus forming the enclosed area 26 after which the portable lavatory 12 is placed within the enclosed area 26. The barrier 14 being formed in a manner such that it blocks unauthorized access to the portable lavatory 12. In addition, providing a passage 16 through the barrier 14 with a custodian 30 enables an individual to pass through the barrier 14 and access the portable lavatory 12 through the passage 16 with an appropriately acquired pass.

The method further includes making available, for purchase and distributing, a pass to an individual desiring to use the portable lavatory 12. The individual upon obtaining a pass presents the pass to the custodian 30 whereby the custodian 30 after reviewing the pass to ensure the authenticity and validity thereof allows the pass holder through the passage 16 thereby granting access to the portable lavatory 12.

In accordance with one aspect of the present invention, the pass is obtained from a separate and distinct pass distribution mechanism 18 or through a pre-advertised scheme. One example of a pass distribution mechanism 18 is an attended ticket booth 18 located on the grounds of the event at which an individual can purchase a pass to use the portable lavatory 12. Accordingly, preferably payment takes place at the pass distribution mechanism 18 and not at the custodian station 34. Accordingly, the custodian 30 does not take payment, but instead checks the authenticity and validity of the respective pass. In an emergency, the custodian 30 can sell the occasional pass for a cash price. However, for obvious reasons of security, pass sales by custodian 30 is not preferred. As set forth above, another method of dispensing the pass involves providing a mechanism, apparatus or machine that receives payment and dispenses a pass.

In addition, one aspect of the present invention involves using a single pass or instrument that can be used a multiple number of times. Wherein each time the pass is used, the custodian 30 records the use. For example, the pass may provide a certain number of uses based upon the payment amount, the amount of which being different from the amount for a single use pass. Thus, multiple usage rates may be at discounted payment.

The term pass as used herein should not be construed to be limited to a specific instrument, item or structure, it shall mean any instrument that notifies the custodian 30, that the holder thereof has previously paid to access the portable lavatory 12. Examples of such instruments include punch cards, vouchers, tickets, coupons, tokens, smart cards, bar coded cards or badges. The foregoing list is not exhaustive and applicant contemplates that other instruments are also suitable.

When use of the sanitation concession 10 is no longer required, the barrier 14, portable lavatory 12 and pass distribution mechanism 18 are removed from the predetermined location. Accordingly, the present invention provides a sanitation concession 10 wherein individuals purchase a pass and pay an agreed-upon price to use the portable lavatory 12. In addition, use of the portable lavatory 12 may be determined based on a combination badge and pass system wherein some individuals may be issued a badge enabling unlimited use of the portable lavatory 12 without needing to obtain a pass. Applicant contemplates that the party requesting the sanitation concession 10 for use at a particular event or location will pay the costs associated with leasing or renting the sanitation concession 10 and keep the revenue generated through the sale of passes.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for controlling access to a portable lavatory, said method comprising the steps of:
providing and placing the said portable lavatory at a predetermined location;
establishing a barrier around said portable lavatory, said barrier blocking unauthorized access to said portable lavatory;
providing a defined passage through said barrier, said defined passage providing access to said portable lavatory within said barrier;
stationing a custodian within said barrier;
distributing at least one pass to access said portable lavatory for use thereof; and
presenting said pass to said custodian whereby said custodian grants access to use of said portable lavatory.

2. A method for controlling access to a portable lavatory as claimed in claim 1 wherein said step of distributing at least one pass further comprises providing a pass distribution mechanism separate and spaced from said barrier; and
using said pass distribution mechanism to dispense said pass granting access to said portable lavatory.

3. A method for controlling access to a portable lavatory as claimed in claim 2 wherein said pass distribution mechanism includes a plurality of passes; and
tendering a payment to obtain one of said plurality of passes.

4. A method for controlling access to a portable lavatory as claimed in claim 1 wherein said pass enables access to said portable lavatory a predetermined number of times.

5. A method for controlling access to a portable lavatory as claimed in claim 2 wherein said pass distribution mechanism further comprises an apparatus for receiving payment and dispensing said passes.

6. A method for controlling usage of a portable comfort station, said method comprising the steps of:
placing a boundary around said portable comfort station such that said portable comfort station is enclosed by said boundary and said boundary limits unauthorized admission to said portable comfort station;
providing a defined entrance through said boundary, said defined entrance allowing access through said boundary to said portable comfort station;
stationing a custodian within said boundary;
obtaining a pass, to use said portable comfort station said pass enabling admission to said portable comfort station located within said boundary;
presenting said pass to said custodian stationed within said boundary;
said custodian examining said pass to determine the validity of said pass; and
said custodian, after making a determination that said pass is valid, allowing the holder of said pass through said defined entrance such that said holder of said pass has access to the use of said portable comfort station.

7. A method for controlling usage of a portable comfort station as claimed in claim 6 wherein said step of obtaining a pass to use said portable comfort station further comprises a pass purchase location separate and spaced from said boundary surrounding said portable comfort station; and
purchasing said pass at said pass purchase location, said pass entitling said holder thereof to use said portable comfort station.

8. A method for controlling usage of a portable comfort station as claimed in claim 7 wherein said step of purchasing said pass at said pass purchase location further comprises the step of tendering payment at said pass purchase location.

9. A method for controlling usage of a portable comfort station as claimed in claim 6 further comprises the steps of providing said pass with usage information indicating a number of authorized admissions to the use of said portable comfort station; and
said custodian after examining said pass, revising said usage information on said pass to reflect the number of times said pass has been used for admission to said portable comfort station such that after the total number of authorized admissions set forth thereon has been reached said pass is collected by said custodian since said pass is no longer valid.

10. A method for controlling usage of a portable comfort station as claimed in claim 6 further comprising the steps of providing said pass with indicia thereon indicating a maximum number of times said pass can be used; and
said step of custodian examining said pass includes the step of making a determination that said pass has not exceeded its maximum use.

11. A portable sanitation concession comprising:
a portable lavatory;
a temporary barrier spaced from, surrounding and limiting unauthorized access to said portable lavatory, said barrier having a passage allowing an individual to pass through said barrier and gain access to said portable lavatory;
a pass dispensing mechanism spaced separate from said passage, said pass dispensing mechanism operative to dispense a pass to gain access to use of said portable lavatory;
a custodian, stationed proximate said passage within said barrier, said custodian reviewing said pass and allowing access to use said portable lavatory through said passage.

12. A portable sanitation concession as claimed in claim 11 wherein said pass is a non-monetary notification instrument.

13. A portable sanitation concession as claimed in claim 11 wherein said pass dispensing mechanism further comprises a payment collection portion and a pass dispensing portion.

14. A portable sanitation concession as claimed in claim 11 wherein said pass has indicia located thereon, said indicia indicating whether said pass is valid for more than one use.

15. A method of generating revenue through use of a portable lavatory, said method comprising the steps of:
providing a portable lavatory of the type suitable for movement to various locations wherein said portable lavatory is temporarily placed at a location for use at said location, said portable lavatory including an enclosure, a porcelain toilet and a porcelain wash basin located within said enclosure, a waste tank located outside and spaced from said enclosure, and a freshwater source supplying freshwater to said porcelain toilet and said porcelain wash basin; and
enabling access to said portable lavatory based on certain criteria, one criterion is paying for access to use said portable lavatory.

16. A method of generating revenue through use of a portable lavatory as claimed in claim 15 wherein said step of enabling access includes providing a custodian to regulate access to said portable lavatory.

17. A method of generating revenue through use of a portable lavatory as claimed in claim 15 wherein said step of enabling access further comprises providing a barrier surrounding said portable lavatory.

18. A method of generating revenue through use of a portable lavatory as claimed in claim 17 wherein said step of enabling access further comprises the steps of an individual paying for and obtaining a pass to use said portable lavatory; and
said individual presenting said pass to said custodian to gain access to said barrier to enable use of said portable lavatory.
